(19) United States
(12) Patent Application Publication
(10) Pub. No.: US 2009/0188841 A1
(43) Pub. Date: Jul. 30, 2009

(54) AUTOMATIC MATERIALS SORTING DEVICE

(75) Inventors: PEI-CHIN KUO, Tu-Cheng (TW); JUEY-FONG CHANG, Tu-Cheng (TW); WEN-TAO WANG, Shenzhen City (CN); ZHI-GANG HU, Shenzhen City (CN); CHAO-YANG SHEN, Shenzhen City (CN); GENG-XIONG WANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/211,050

(22) Filed: Sep. 15, 2008

(30) Foreign Application Priority Data
Jan. 29, 2008 (CN) 200810300249.9

(51) Int. Cl. B07C 5/00

(52) U.S. Cl. 209/564; 209/577

(57) ABSTRACT

An exemplary automatic materials sorting device (100) includes an input belt (11) for transporting materials, a materials sorting mechanism (12), and a control system. The materials sorting mechanism is connected to the input belt, and includes two output belts (121, 122). The input belt and the output belts are configured to transport materials. The control system includes two acting mechanisms (14, 15) and a controller (16). The controller is configured to control the acting mechanisms. The acting mechanisms are capable of creating a force to push the materials to the output belts.

### BACKGROUND OF THE INVENTION

1. Field of the Invention

The present invention relates to automatic materials sorting devices and, more particularly, to an automatic materials sorting device for sorting materials by moving them along two or more different directions.

2. Discussion of the Related Art

In the process of making products, materials generally need to be sorted and moved along different directions. A typical materials sorting device includes an input belt and two output belts formed on an end of the input belt. The input belt and the output belts are configured to transport materials. When materials are being separated, sorted materials are moved from one input belt to selected input belts manually. However, such a method to manually sort materials has low efficiency and high cost. The method also easily leads the operators to be tired out.

Therefore, a materials sorting device which can automatically separate materials is desired.

### SUMMARY

An automatic materials sorting device includes an input belt for transporting materials, a materials sorting mechanism, and a control system. The materials sorting mechanism is connected to the input belt, and includes two output belts. The input belt and the output belts are configured to transport materials. The control system includes a controller and two acting mechanisms. The controller is configured to control the acting mechanisms. The acting mechanisms are capable of creating a force to push the materials to the output belts.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present automatic materials sorting device. Moreover, in the drawings, like reference numerals designate corresponding parts throughout the several views.

FIG. 1 is a schematic, isometric view of an automatic materials sorting device according to a first embodiment.

FIG. 2 and FIG. 3 are functional block diagrams of controlling the automatic materials sorting device in FIG. 1.

FIG. 4 is a schematic, isometric view of an automatic materials sorting device according to a second embodiment.

FIG. 5 is a schematic, isometric view of an automatic materials sorting device according to a third embodiment.

### DETAILED DESCRIPTION OF THE EMBODIMENTS

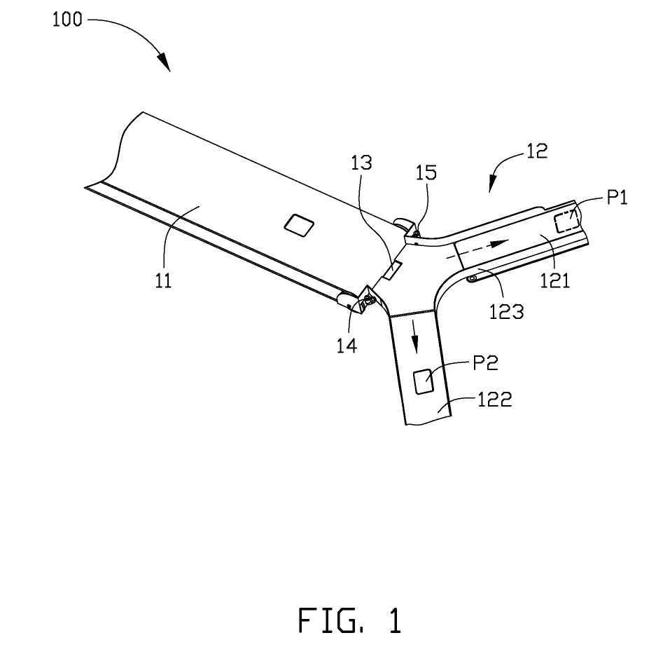

Referring to FIG. 1, an automatic materials sorting device 100 in accordance with a first embodiment is shown. The automatic materials sorting device 100 includes an input belt 11, a materials sorting mechanism 12. The materials sorting mechanism 12 is connected to an end of the input belt 11, and includes two output belts 121, 122. The input belt 11 and the output belts 121, 122 are configured for transporting half-finished products. An angle between the output belts 121, 122 is substantially 90 degrees. Two guard rails 123 are formed perpendicularly from opposite sides of, but not connected with, the output belts 121, 122. The guard rails 123 are configured to prevent materials from falling off the output belts 121, 122.

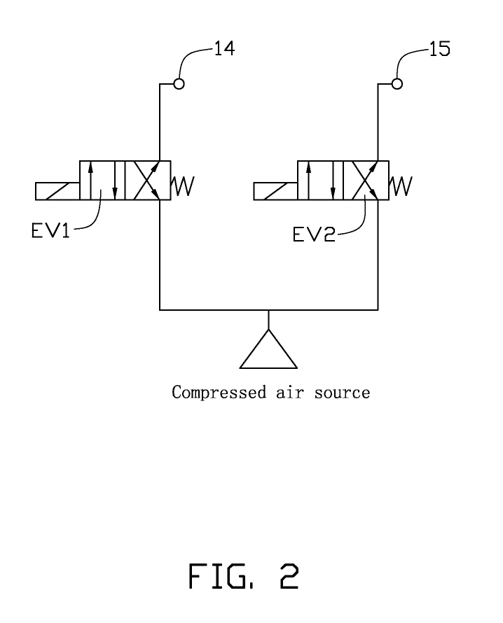

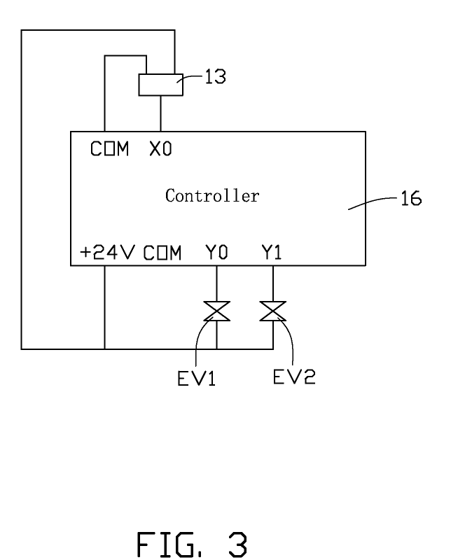

Referring also to FIGS. 2 and 3, the materials sorting mechanism 12 includes a control system. The control system includes a sensor 13, two electromagnetic valves EV1, EV2, two air nozzles 14, 15, and a controller 16. The sensor 13 is disposed on a middle portion of the end of the materials sorting mechanism 12 connected to the input belt 11. The sensor 13 is configured for detecting half-finished products transported to the end of the input belt 11, and sending signals to the controller 16. In this embodiment, the sensor 13 is a photoelectric sensor. The controller 16 is a programmable logic controller (PLC).

The air nozzles 14, 15 are disposed on opposite sides of the materials sorting mechanism 12 correspondingly, and are adjacent to the end of the input belt 11. The air nozzles 14, 15 are configured for spraying compressed air, and controlled by the controller 16.

When a half-finished product P1 is transported to the end of the input belt 11, the sensor 13 detects the half-finished product P1, and a switch of the sensor 13 sends a signal to an input interface X0 of the controller 16. Then, the controller 16 sends a signal to the electromagnetic valve EV1 via the output interface Y0. The electromagnetic valve EV1 is opened, and controls the air nozzle 14 to spray compressed air for three seconds. The compressed air creates a force that pushes the half-finished product P1 to the output belt 121.

When a half-finished product P2 is transported to the end of the input belt 11, the sensor 13 detects the half-finished product P2, and the switch of the sensor 13 sends a signal to an input interface X0 of the controller 16. Then, the controller 16 sends a signal to the electromagnetic valve EV2 via the output interface Y1. The electromagnetic valve EV2 is opened, and controls the air nozzle 15 to spray compressed air for three seconds. The compressed air creates a force to push the half-finished product P2 to the output belt 122.

It should be understood that, the angle between the output belts 121, 122 may be adjusted, such as 180 degrees, that is, the output belts 121, 122 are aligned in a same line. The time of spraying compressed air via air nozzles 14, 15 is changeable.

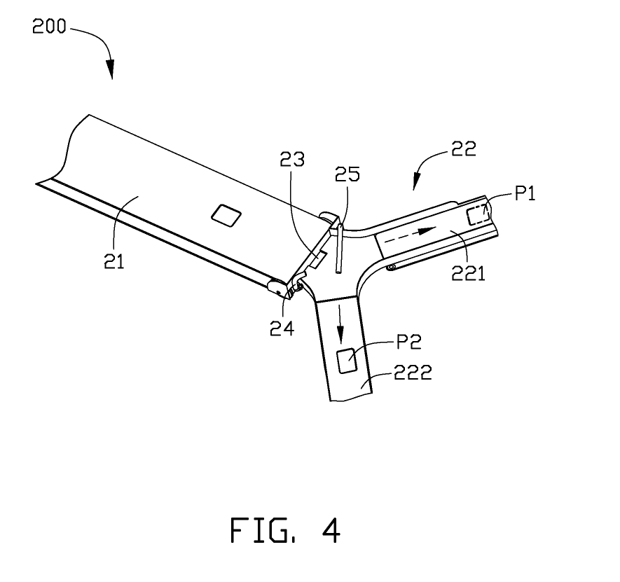

Referring to FIG. 4, an automatic materials sorting device 200 in accordance with a second embodiment is shown. The automatic materials sorting device 200 is similar to the automatic materials sorting device 100 except that the air nozzles 14, are replaced by two movable arms 24, 25 respectively, and the electromagnetic valves EV1, EV2 are omitted. The length of the movable arms 24, 25 is changeable.

When a half-finished product P1 is transported to an end of an input belt 21, a sensor 23 detects the half-finished product P1, and a switch of the sensor 23 sends a signal to an input interface X0 of the controller 16. Then, the controller 16 creates a signal for controlling the movable arm 24 to push the half-finished product P1 to an output belt 221. When a half-finished product P2 is transported to an end of an input belt 21, the sensor 23 detects the half-finished product P2, and a switch of the sensor 23 sends a signal to an input interface X0 of the controller 16. Then, the controller 16 creates a signal, and the signal controls the movable arm 25 to push the half-finished product P2 to an output belt 222.

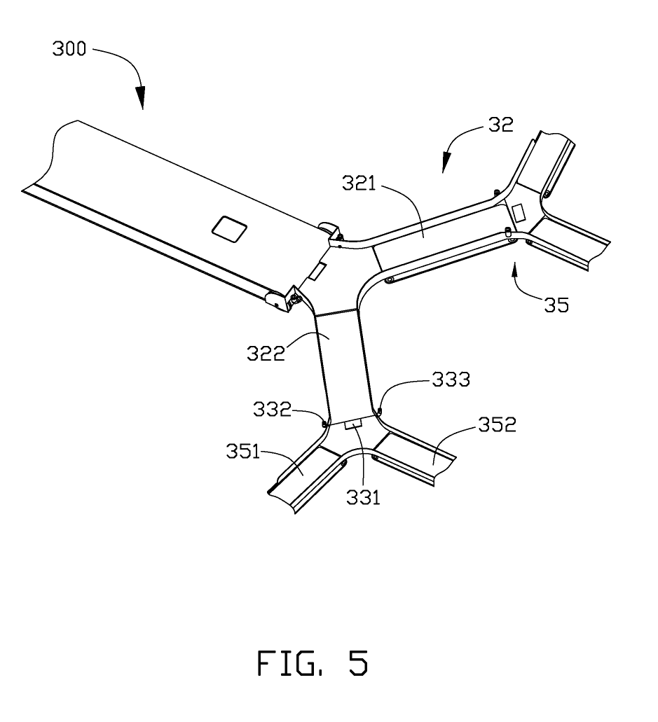

In alternative embodiments, the automatic materials sorting device may include a plurality of the materials sorting mechanisms 12 connected to each other. Referring to FIG. 5, an automatic materials sorting device 300 in accordance with a third embodiment is shown. The automatic materials sorting device 300 includes a first materials sorting mechanism 32 and two second materials sorting mechanisms 35. The first materials sorting mechanism 32 includes two output belts 321, 322. The second materials sorting mechanisms 35 are connected to the ends of the output belts 321, 322 respectively. Each of the second materials sorting mechanisms 35 includes two output belts 351, 352 and a control system. The control system includes a sensor 331, a controller (not shown), two electromagnetic valves (not shown), and two air nozzles 332, 333. The sensor 331 is disposed on a middle portion of the end of the second materials sorting mechanism 35 connected to the first materials sorting mechanism 32. The air nozzles 332, 333 are disposed on opposite sides of the end of the second materials sorting mechanism 35 connected to the first materials sorting mechanism 32. When half-finished products are transported to the ends of the output belts 321, 322, for reasons similar to those described above in relation to the automatic materials sorting device 100, the second materials sorting mechanisms 35 can separate the half-finished products to move along four different directions.

Alternatively, the air nozzles 14, 15, 332, 333 and the movable arms 24, 25 may be replaced by other acting mechanisms, such as manipulators. Each of the materials sorting mechanisms 12, 22, the first materials sorting mechanism 32, and the second materials sorting mechanism 35 may include more than two output belts. In such cases, an amount of the acting mechanisms corresponds to the amount of the output belts.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An automatic materials sorting device, comprising:
at least one materials sorting mechanism, each of the at least one materials sorting mechanism including at least two output belts, the at least two output belts being configured to transport materials; and
a control system including a controller and at least two acting mechanisms, the controller configured to control the at least two acting mechanisms, the at least two acting mechanisms being capable of creating a force to push the materials to the at least two output belts correspondingly.

2. The automatic materials sorting device as claimed in claim 1, wherein the control system further comprises a sensor, the sensor is configured to detect the materials transported to the at least one materials sorting mechanism and to send signals to the controller.

3. The automatic materials sorting device as claimed in claim 2, further comprising an input belt, wherein the number of the at least one materials sorting mechanism is one, the materials sorting mechanism is connected to the input belt, and the materials sorting mechanism includes two output belts.

4. The automatic materials sorting device as claimed in claim 3, wherein the control system further comprises two electromagnetic valves, the at least two acting mechanisms are two air nozzles, the air nozzles are controlled by the two electromagnetic valves correspondingly.

5. The automatic materials sorting device as claimed in claim 4, wherein the sensor is disposed on a middle portion of the end of the materials sorting mechanism connected to the input belt, the air nozzles are disposed on opposite sides of the materials sorting mechanism respectively, when the controller receives a signal sent by the sensor, the electromagnetic valves are controlled by the controller, and the air nozzles spray compressed air to push the materials to the output belts correspondingly.

6. The automatic materials sorting device as claimed in claim 3, wherein the at least two acting mechanisms are two movable arms.

7. The automatic materials sorting device as claimed in claim 6, wherein the sensor is disposed on a middle portion of the end of the materials sorting mechanism connected to the input belt, the movable arms are disposed on opposite sides of the materials sorting mechanism, when the controller receives a signal sent by the sensor, the controller controls the movable arms to push the materials to the output belts correspondingly.

8. The automatic materials sorting device as claimed in claim 1, wherein the automatic materials sorting device further comprises an input belt, the number of the at least one materials sorting mechanism is three, the three materials sorting mechanism are a first materials sorting mechanism and two second materials sorting mechanism, the first materials sorting mechanism is connected to an end of the input belt, and the number of at least two output belts is two, the second materials sorting mechanism are connected to the output belts of the first materials sorting mechanism respectively.

9. The automatic materials sorting device as claimed in claim 2, wherein the sensor is a photoelectric sensor.

10. The automatic materials sorting device as claimed in claim 1, wherein the controller is a programmable logic controller.

11. The automatic materials sorting device as claimed in claim 1, wherein two guard rails formed perpendicularly from opposite sides of each of the at least two output belts, the guard rails are not connected with the belt.

12. An automatic materials sorting device, comprising:
an input belt for transporting materials;
a materials sorting mechanism connected to the input belt, the materials sorting mechanism including at least two output belts, the at least two output belts being configured to transport materials; and
a control system including a controller, a sensor connected to the controller, and at least two acting mechanisms, the controller configured to control the at least two acting mechanisms, the at least two acting mechanisms being capable of creating a force to push the materials to the at least two output belts.

13. The automatic materials sorting device as claimed in claim 12, wherein the sensor is a photoelectric sensor.

14. The automatic materials sorting device as claimed in claim 12, wherein the controller is a programmable logic controller.
